(19) United States
(12) Patent Application Publication
(10) Pub. No.: US 2010/0280963 A1
(43) Pub. Date: Nov. 4, 2010

(54) PRODUCT RECALL SERVICE

(76) Inventors: Edward W. Fordyce, III, Sedalia, CO (US); Nurtekin Savas, San Jose, CA (US)

Correspondence Address: Quarles & Brady LLP, TWO NORTH CENTRAL AVENUE, One Renaissance Square, PHOENIX, AZ, 85004-2391, US

(21) Appl. No.: 12/770,607

(22) Filed: Apr. 29, 2010

Related U.S. Application Data
(60) Provisional application No. 61/174,402, filed on Apr. 30, 2009.
(60) Provisional application No. 61/293,359, filed on Jan. 8, 2010.

(51) Int. Cl. G06Q 10/00

(52) U.S. Cl. 705/303

(57) ABSTRACT

Participating merchants send transaction data to a Product Recall Service (PRS). Each such transaction data received by the PRS from a merchant identifies a product purchased, an account holder making the purchase, the merchant from which the product was purchased, and an account issued to the account holder by an issuer upon which the transaction was conducted. When a supplier of the product to the merchant announces a recall of the product to the PRS, the PRS mines previously received transaction data, in conjunction with information obtained from transaction handler in a payment processing system, to send announcements to the account holders who conducted transactions to purchase the recalled product, and optionally to assign one or more globally unique identifiers that characterize and specify the product recall. Each account holder can use a web-enabled device to send information to, and receive information from, the PRS. The PRS communicates information received about the product recall to the supplier.

CROSS-REFERENCE TO RELATED FILES

This application claims priority to, and the benefit of, U.S. Application Ser. No. 61/174,402, titled “Product Recall Service,” filed on Apr. 30, 2009, and to U.S. Application Ser. No. 61/293,359, titled “Product Recall Service,” filed on Jan. 8, 2010, both of which are incorporated herein by reference.

### FIELD

Implementations generally relate to sales by manufacturers, and more particularly to a recall of a product sold by a manufacturer.

### BACKGROUND

Manufacturers who recall a product go through a laborious, expensive process in attempts to contact customers who are likely to have purchased its products in order to let them know that the product has been recalled, should be returned, and/or is not safe to use or consume. Manufacturers are often challenged to identify the consumers who purchased the lot, batch or order of the product that has been recalled, typically because, for most products, consumers have been registered their purchase with the manufacturer.

Manufacturers currently use mass media messages (television, radio, newspapers and magazines, the Internet), direct mail and phone contact to reach out to consumers, to alert them to a product's recall, and to request that the consumer return the product in question and/or stop using the product. Such prior art product recall notification methodologies are not rapid in warning a specifically targeted consuming public about a specific product that has been recalled, often at substantial peril for public safety. For instance, when a manufacturer would like to send out an emergency notice that a certain food item that it has put into the stream of commerce has been recalled for public safety reasons, the length of a delay in providing an effective notice to those consumers who purchased and are likely to consume the food item may result in a corresponding increase in a risk of sickness and death. Accordingly, the sooner that effective notice is given to specifically targeted consumers, even up to the stopping of a transaction in real time at a merchant's Point of Service terminal during a purchase of the recalled product by a consumer, may be significant enhancement to public safety.

Prior art product recall notification methodologies are inefficient, resulting in a low number of effective notices being delivered to the proper consumers, and realizing a substantial expense incurred by the manufacturer for an insubstantial return in making the proper consumers aware of a public safety issue. Accordingly, it would be an advance in the relevant art to provide product recall methodologies that reduces the foregoing problems.

### SUMMARY

In one implementation, a product recall service communicates via a network to facilitate real time electronic product recall alerts generated from transactional data acquired at Point of Service terminals and prior registrations of account holders with the product recall service. Each electronic alert is sent either to an account holder who purchased a recalled product on an account issued to them by an issuer, or to the issuer for delivery to their account holders who purchased a recalled product on an account issued by the issuer.

In yet another implementation, a plurality of different recall notices from a plurality of different suppliers of a plurality of different recalled products are received. For transactions conducted with a plurality of different merchants on a plurality of different accounts issued to a plurality of different account holder by a plurality of different issuers, where each transaction identifies a purchased item, a comparison is made of an identifier for each of the purchased items of the transactions with an identifier for each of the recalled products to identify each said transaction where the purchased item was one of the recalled products. For each item purchased in each transaction that corresponds to each of the recalled products, a recall message is sent to a logical address. The logical address can be that of each issuer of each account that was used to conduct one of the transactions to purchase one of the recalled products. The logical address can be that of each account holder of each account that was used to conduct one of the transactions to purchase one of the recalled products. A fee can be assess to each supplier of each recalled product for use of a recall notification service. Where the issuer sends recall notifications to each of its account holders who purchased a recalled product on an account issued to them by the issuer, a portion of each such supplier-paid fee can be paid to issuer of each account used to conduct one of the transactions to purchase one of the recalled products. An account holder receiving a recall notification can interactively communicate with the supplier of the recalled product to send and receive information provider about the recall product.

In still another implementation, a product recall service communicates via a network to facilitate real time electronic alerts generated from transactional data acquired at Point of Service terminals and prior registrations of account holders with the product recall service. Each electronic alert is sent either to an account holder who purchased a recalled product on an account issued to them by an issuer, or to the issuer for delivery to their account holders who purchased a recalled product on an account issued by the issuer.

### BRIEF DESCRIPTION OF THE DRAWINGS

Implementations will become more apparent from the detailed description set forth below when taken in conjunction with the drawings, in which like elements bear like reference numerals.

FIG. 1 depicts a block diagram illustrating an exemplary environment for a product recall service;

FIG. 2 depicts a flowchart of an exemplary method, that can be performed in the environment of FIG. 1, for a product recall service;

FIG. 3 depicts a block diagram illustrating another exemplary environment for a product recall service;

FIG. 4 depicts a flowchart of an exemplary method, that can be performed in the environment of FIG. 3, for a product recall service;

FIG. 5 shows an exemplary interactive display screen, in a exploded view thereof, by which an account holder can use a web-enabled device to access a product recall service network interface via the Internet for an exchange of information, for instance, relative to a recalled product; and

FIG. 6 depicts a block diagram of an exemplary payment processing system that can be operated in the environment of FIGS. 1 and 3.

### DESCRIPTION

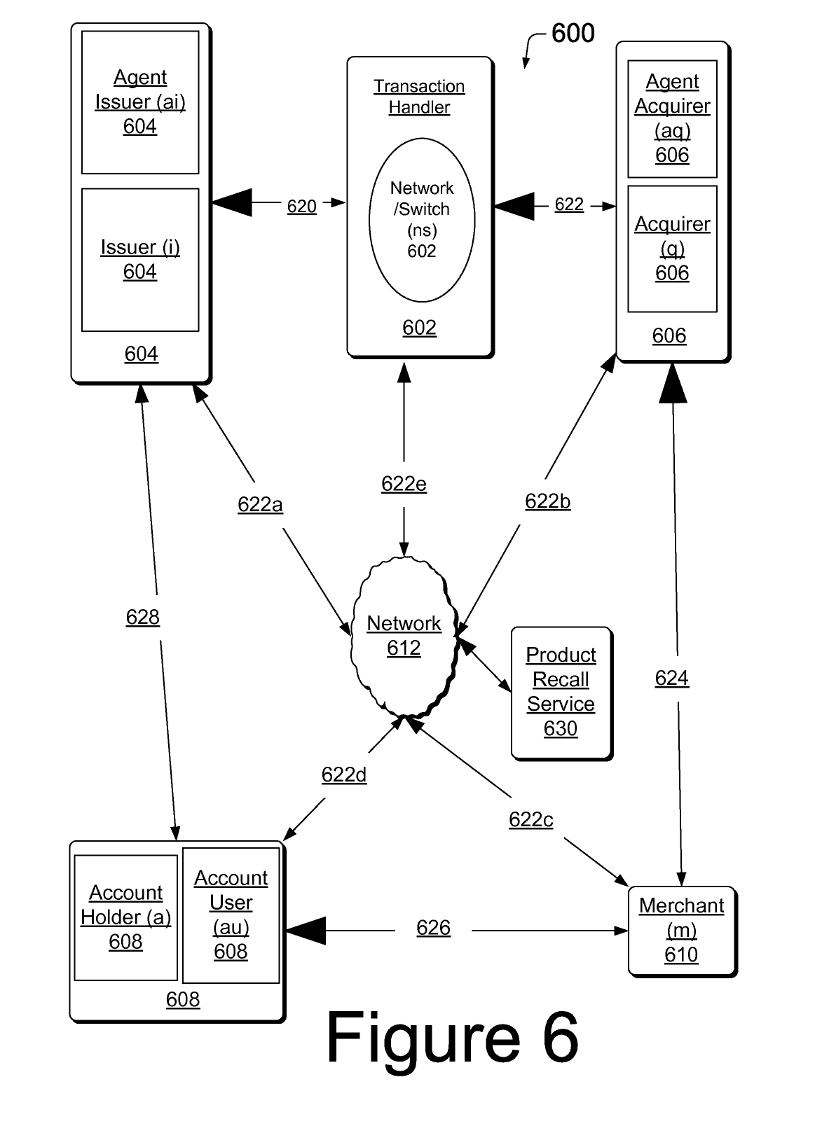

Implementations of a product recall service provide cost effective notifications to consumers that a product they have purchased has been recalled by the manufacturer. In one implementation, manufacturers or suppliers of products manufactured by others, merchants and account holders would be registered as participants in a Product Recall Service (PRS). Each participating merchant would send, for delivery to the PRS, transaction data sufficient to identify each account holder making a purchase from the merchant and their purchased items. Each such purchased item would be part of a transaction conducted on an account issued to the account holder by an issuer, where the transaction was conducted by the merchant with the account holder. Payment to the merchant for the transaction would be authorized by the issuer to the merchant's acquirer, and would be cleared and settled through a payment processing system as discussed below with respect to FIG. 6.

Upon notice received by the PRS from a participating supplier, where the notice identifies the supplier's recalled product, the PRS would match the recalled product against transaction data accumulated from participating merchant's transactions in order to locate those participating account holders who had purchased the recalled product. For each such match, contact information about the matching participating account holders would be used to send a notice. This notice would identify the recalled product and contain a product recall message that the supplier would like to send to the account holders who had purchased the recalled product. The notice may also contain a request from the supplier to the account holders to return the product for a refund, for instance, by providing a phone number or e-mail address for account holders to contact the supplier or its agent. The notice may also provide an Internet address, which may be hosted by the PRS, at which the account holders can give and receive information about the recalled product. Such data, as was given to and received from account holders, can then be passed on to the supplier, or its agent, by the PRS.

Advantageously, the PRS need not make contact with a participating merchant every time a recall happens, and the merchant's acquirer need not be required to gather and match data against account holders who purchased a recalled product from the merchant. Rather, the merchant sends, for delivery to the PRS, transaction data information for items purchased in transactions by account holders, regardless of whether each such item has been recalled. Upon receipt, the PRS stores such transaction data along with data sufficient to identify, and derive contact information for, each account holder that is privy to each such transaction.

When a participating supplier announces a product recall to the PRS, there is no need to contact either the merchant or its acquirer in order to provide effective notice to the relevant account holders who had previously purchased the recalled product. As such, network traffic to both the merchant and its acquirer are not substantially increased by each product recall. Moreover, implementation costs to the acquirer are not substantial in working with the PRS to facilitate product recall notices to account holders.

Participating merchants acquire data at the time of each transaction with each account holder sufficient to identify both the account holder and each item purchased in the transaction. Such data may include, for the account holder, an account identifier issued by an issuer to the account holder, a transaction identification number for the transaction, the date and time of the transaction, a Point of Service terminal (POS) identifier, etc. Such data may include, for the item being purchased in the transaction, ‘level three’ data, product level data, or other data such as a Stock Keeping Unit (SKU), a Universal Product Code (UPC), a supplier's serial number, a supplier's batch and lot identifier, date and location of manufacture, etc.

These POS data can be sent directly to the PRS, or can be sent for delivery to the PRS via the merchant's acquirer and a transaction handler. These POS data can be send in real time, or periodically in batch mode, and need not be part of a clearing and settlement process for the collection of the merchant's payment for a transaction.

Advantageously, the PRS provides an incentive for account holders to be loyal to those merchants who receive and send such product level data as it enables account holders to enrich their participation in the PRS. Similarly, suppliers may be more favorably disposed to such merchants, or their acquirers, because of their capabilities as PRS participants.

In the event that a participating account holder has one or more accounts that are closed or otherwise become unusable for future transactions, the PRS can be so notified of such an event by its account holder, by its issuer, or by a credit rating service (i.e.; Experian, TransUnion, Equifax, etc.) that keeps credit histories based on social security numbers or other globally unique identifiers for consumers. Also, the PRS may detect inactivity in the account for a predetermined time threshold. In such cases, the PRS can attempt to contact the participating account holder to continue the recall service, and retain the accumulated data about products purchased by the account holder, despite the closing or lack of future usefulness of the account holder's account.

In one implementation, an account holder can self register with the PRS for some or all of the accounts that they hold such that the respective issuers of these accounts need not register the account holder with the PRS. Moreover, the account holder can continually update the PRS with purchases of products made at non-participating merchants, as well as continually updating their contact information along with chronologically opened and closed account information. These updates enable the PRS to retain product purchase information about the participating account holder which can be used to timely notice of product recalls to participating account holder. Self registration by an account holder, and ongoing maintenance of account holder information, can be accomplished, for instance, by an online registration service, such as at a website hosted by the PRS or its agent. Accordingly, self registration allows an account holder to be free of its issuers and still be notified of about its purchased products that have been recalled, even if the account holder no longer has a banking relationship with an issuer who issued an account to the account holder upon which a recalled product was purchased. Accordingly, and for example, such an account holder may receive a product recall notice many years after the recalled product was purchased by the account holder, even though the account used by the account holder to purchase the product was closed many year ago. Advantageously, data acquired and maintained by the PRS can be mined for other purposes beneficial to registered participants with the PRS. For instance, a participating supplier may want to send a notice of all participating account holders residing in a particular geographic area who have purchased its participating products, such as to announce a special event at on a particular date and time in that geographic area. As such, the PRS can perform various functions and serve in various capacities as may have been previously performed by a supplier product registration service by which a consumer would have registered purchases of the supplier's goods with the supplier.

In one implementation, a web-based registration system could be used for suppliers to provide the information on the recalled products (e.g.; SKU, UPC, etc.) and the recall notification message contents. Other entities would also use this web-based system to register their participation in the PRS, as well as for other services such as receiving reports made available via this interface (e.g.; related billing and operational information pertaining to PRS participants).

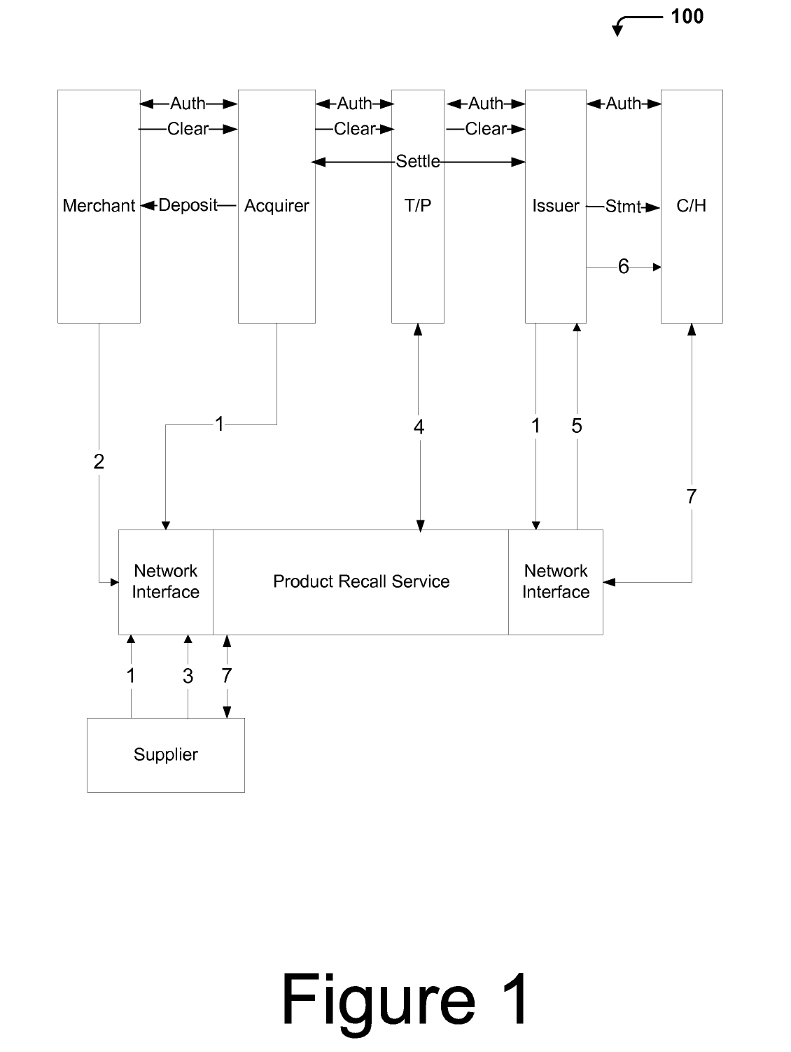

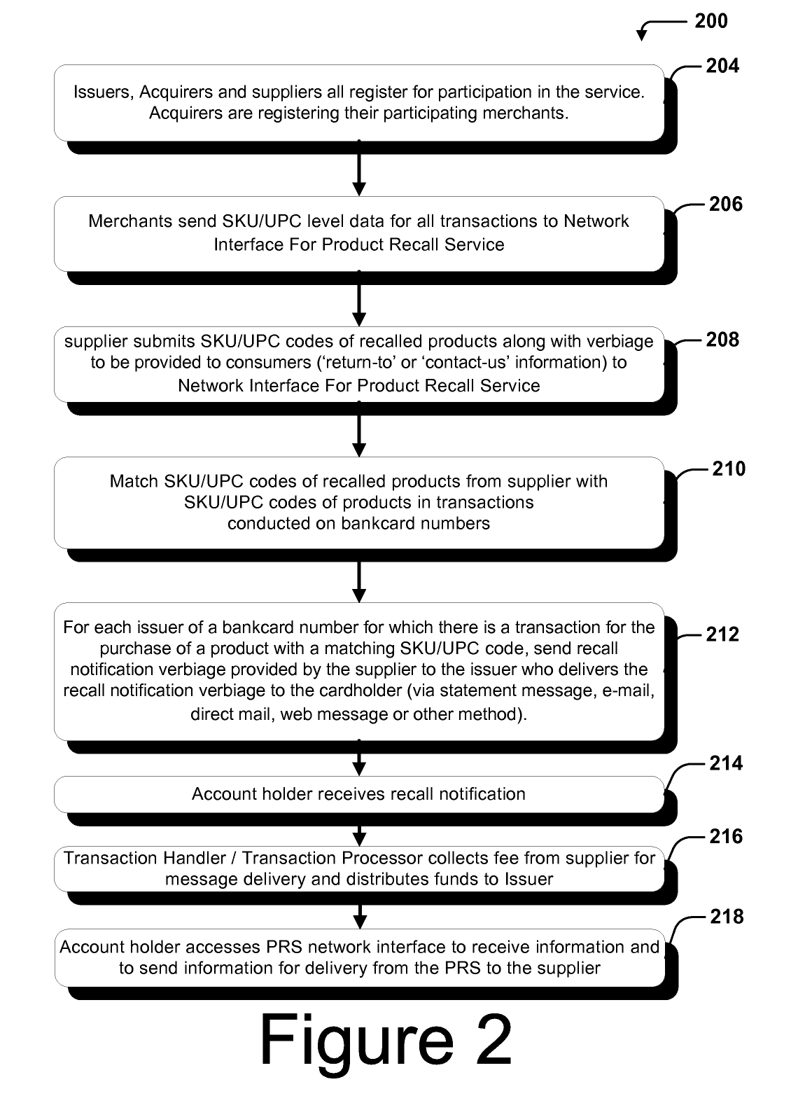

Referring to FIGS. 1-2, an environment 100 for a method 200 is shown. In step 204 of method 200, corresponding to arrows labeled ‘1’ in FIG. 1, issuers register their account holders and acquirers register their merchants for participation in a Product Recall Service (PRS) to a network interface for the PRS.

In step 206, corresponding to arrows labeled ‘2’ in FIG. 1, participating merchants send product level data for some or all items for some or all transactions to the PRS via a Network Interface. For example, the product level data can be sent from the participating merchant to its acquirer for forwarding to transaction handler and from the transaction to the PRS, where the transaction is authorized, cleared, and settled in a payment processing system such as will be described below with respect to FIG. 6.

In step 208, corresponding to arrows labeled ‘3’ in FIG. 1, participating suppliers submit product identifiers of recalled products along with verbiage to be provided to account holders consumers (‘return-to’ or ‘contact-us’ information) to a network interface for the PRS. To do so, a supplier can submit an identifier for each product, such as an SKU, UPC, serial number, etc. Alternatively, each such identifier can be submitted either before or after the corresponding product is recalled. The supplier can also provide verbiage to be provided to account holders (i.e.; return-to, contact-us information, etc.)

In step 210, corresponding to arrows labeled ‘4’ in FIG. 1, the PRS works in conjunction with the transaction handler to match the product identifier for a recalled product against the product level data accumulated from transactions between merchants and account holders. With the finding of the recalled product matches in the transaction data, the PRS, working in conjunction with the transaction handler, can derive and use other information from the matching transaction data. For instance, by mining the matching transaction data, the PRS can assign Globally Unique Identifiers (GUIDs) that characterize and specify the product recall. For instance, the particular product(s) that were purchased by a particular account holder can each be assigned a recalled product GUID. The particular transaction in which the particular product(s) were purchased by the particular account holder can be assigned a transaction GUID. The particular merchant that sold the particular product(s) to that particular account holder can be assigned a merchant GUID. The particular location at which the particular merchant sold the particular product(s) to the particular account holder can be assigned a merchant location GUID. Each such GUID can be communicated to the particular account holder and/or the supplier as further described below with respect to FIG. 6 and as shown corresponding to the arrows labeled ‘7’ in FIG. 1. Upon receipt, the GUIDs can be used by a supplier of a recalled product to take measures to limit personal injury and property damage.

In step 212, corresponding to arrows labeled ‘5’ in FIG. 1, a notice is sent to each issuer having one or more accounts upon which there had been a transaction conducted for the purchase of a product with a matching product identifier of a recalled product. The notice sent to the issuer contains recall notification verbiage provided by the supplier for delivery to the issuer's account holders who conducted the corresponding transactions for the purchase of a recalled product, and may also include the recalled product GUID.

In step 214, corresponding to arrows labeled ‘6’ in FIG. 1, the recall notification verbiage is sent from the issuers to their respective account holders who conducted the corresponding transactions for the purchase of a recalled product, and may also include a respect recalled product GUID. The recall notification verbiage can be sent to each account holder via statement message, e-mail, direct mail, text or web message, or other method.

In step 216, the transaction handler, the PRS, or their agent, collects a fee from the supplier for product recall message delivery services and distributes all or respective portions thereof to each participating entity that assisted in the product recall message delivery service. By way of example, the fee can be a product recall service fee that is collected from a supplier of a product that has been recalled product. A portion of each such product recall service fee can been be paid to each issuer who had issued an account that was used by an account holder to purchase the corresponding recalled product. The issuer can send a recall notice to each such account holder, where the fee received by the issuer can be deemed to be compensation for such product recall notifications to its account holders.

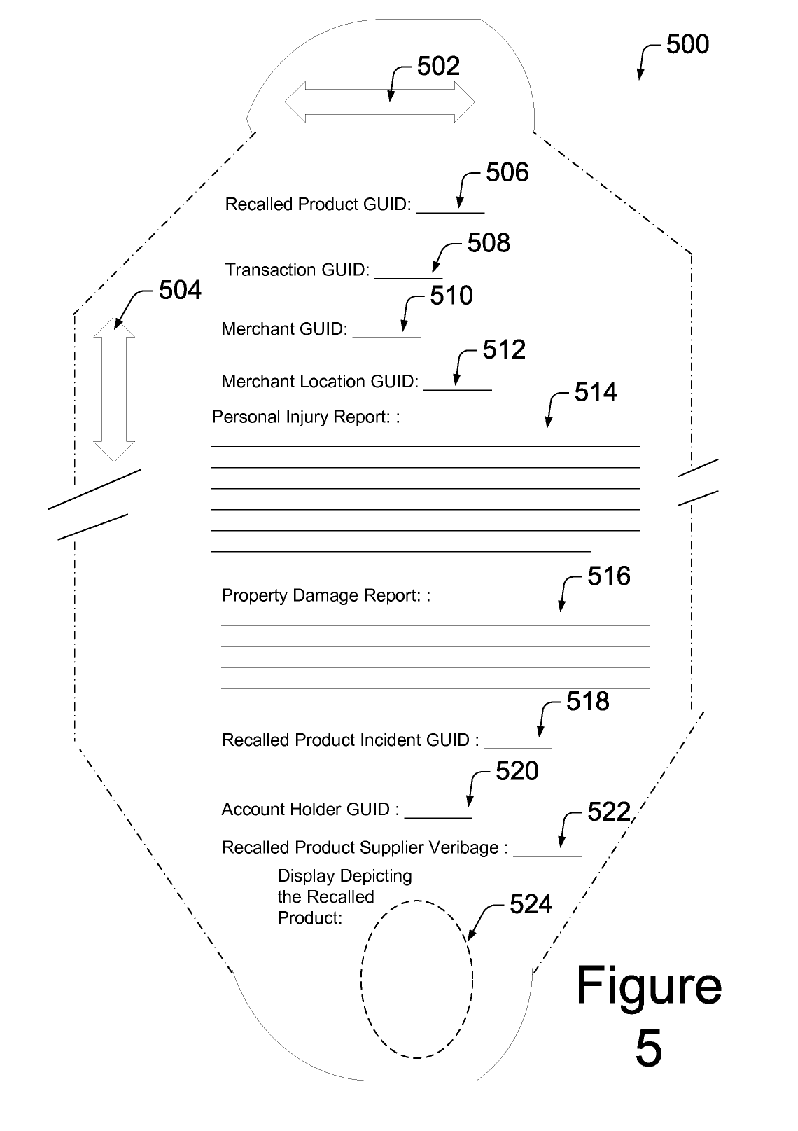

In step 218, corresponding to arrows labeled ‘7’ in FIG. 1, each account holder accesses a PRS network interface to send data to and receive data from the supplier and/or the PRS which may pertain to a previously purchased recalled product. By way of example, and not by way of limitation, the account holder can use a web-enabled device to access the PRS network interface via the Internet, such as via a user interface having an interactive display screen 500 as discussed below with respect to FIG. 5. Such access by the account holder may require the input of the recalled product GUID as received in the product recall notice.

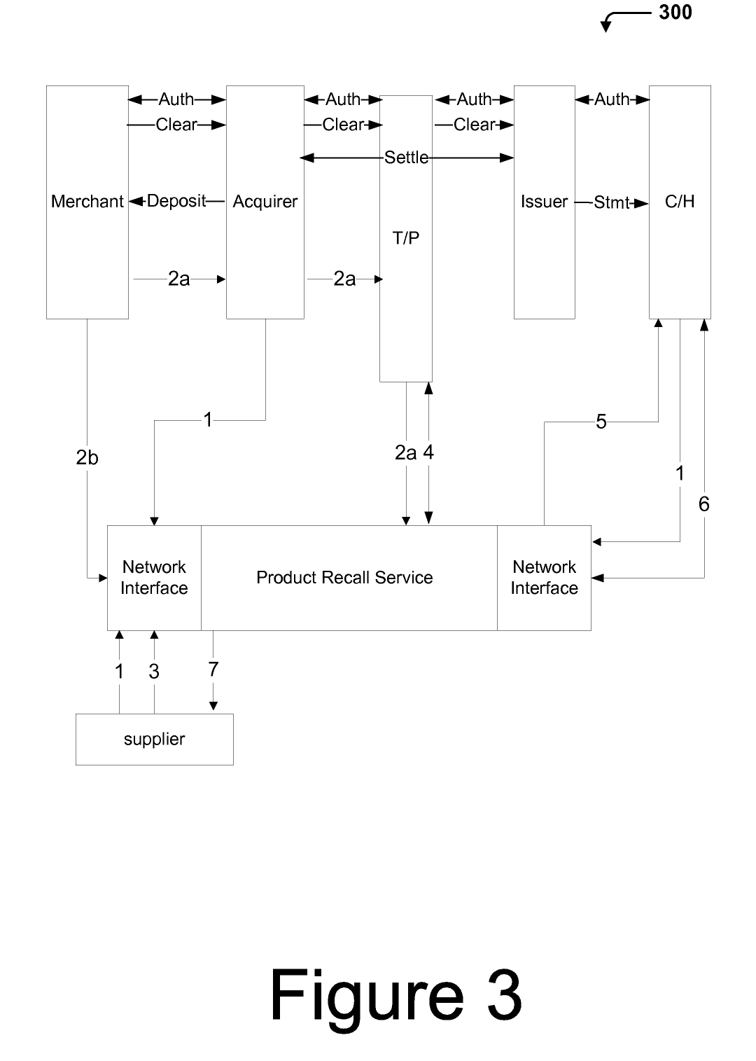

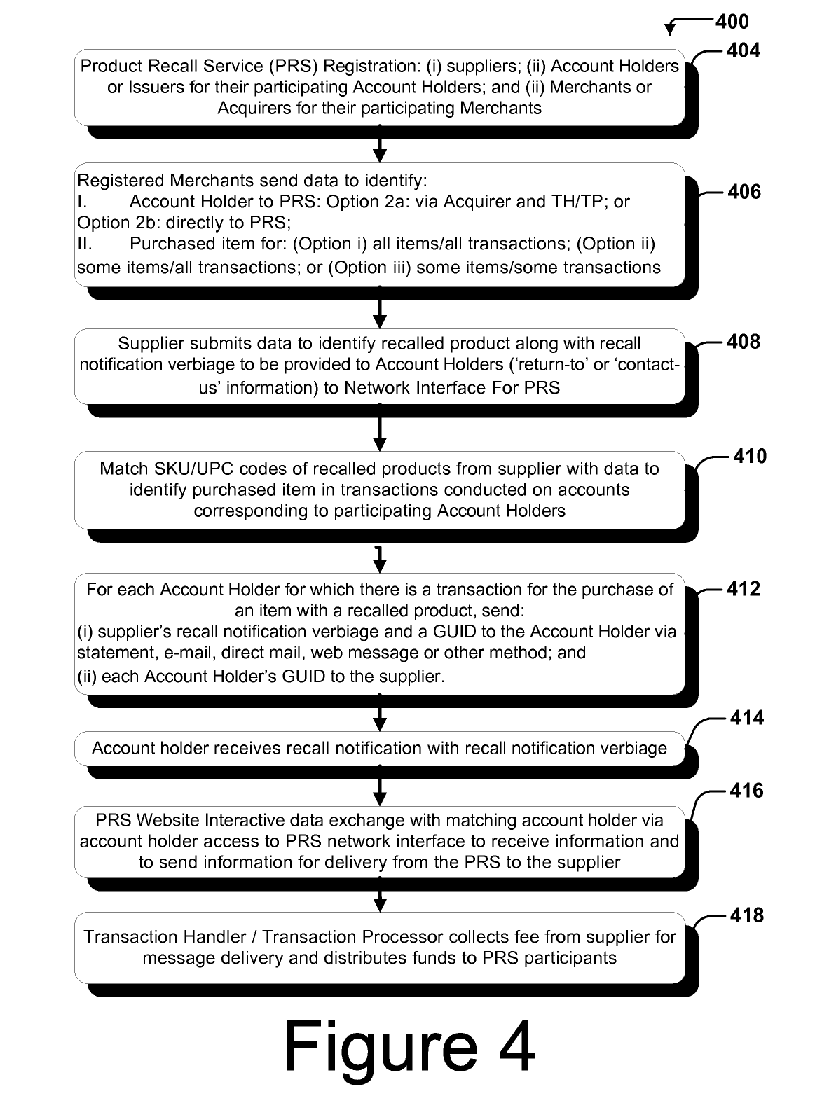

Referring to FIGS. 3-4, an environment 300 for a method 400 is shown. In step 404 of method 400, corresponding to arrows labeled ‘1’ in FIG. 3, a Product Recall Service (PRS) facilitates registration from (i) suppliers; (ii) from account holders; and (ii) from merchants and/or from acquirers for their participating merchants.

In step 406, corresponding to arrows labeled ‘2a’ and ‘2b’ in FIG. 3, registered merchants send data from transactions with account holder, where each transaction is authorized, cleared, and settled in a payment processing system such as will be described below with respect to FIG. 6. The data from these transaction is sufficient to identify: (A) account holders to the PRS, with an option 2a to send these data to the PRS via the merchant's acquirer and the transaction handler, or with an option 2b where the merchant sends these data directly to the PRS. Also in step 406, the registered merchants send transaction data that identifies (B) purchased items for, an option i) all items in all transactions, an option ii) some items of the items in all transactions, or an option iii) some of the items in some of the transactions. Note the only some items may be ‘participating’ items in a product recall service, where participating item are so qualified, for instance, by: (I) product level data was received by the merchant at the merchant's POS such that these data can be sent to the PRS; (II) a participating entity (i.e.; a supplier, an account holder, a merchant, an issuer) requested that transactions for the purchase of certain items be tracked by the PRS; (III) a governmental agency required that transactions for the purchase of certain items be tracked by the PRS.

In step 408, corresponding to arrows labeled ‘3’ in FIG. 3, participating suppliers submit product identifiers of recalled products along with verbiage to be provided to account holders consumers (‘return-to’ or ‘contact-us’ information) to a network interface for the PRS. To do so, a supplier can submit an identifier for each product, such as an SKU, UPC, serial number, etc. Alternatively, each such identifier can be submitted either before or after the corresponding product is recalled. The supplier can also provide verbiage to be provided to account holders (i.e.; return-to, contact-us information, etc.)

In step 410, corresponding to arrows labeled ‘4’ in FIG. 3, the PRS works in conjunction with the transaction handler to match the product identifier for a recalled product against the product level data accumulated from transaction between merchants and account holders. With the finding of the recalled product matches in the transaction data, the PRS, working in conjunction with the transaction handler, can derive and use other information from the matching transaction data. For instance, by mining the matching transaction data, the PRS can assign Globally Unique Identifiers (GUIDs) that characterize and specify the product recall. For instance, the particular product(s) that were purchased by a particular account holder can each be assigned a recalled product GUID. The particular transaction in which the particular product(s) were purchased by the particular account holder can be assigned a transaction GUID. The particular merchant that sold the particular product(s) to that particular account holder can be assigned a merchant GUID. The particular location at which the particular merchant sold the particular product(s) to the particular account holder can be assigned a merchant location GUID. Each such GUID can be communicated to the particular account holder and/or the supplier as further described below with respect to FIG. 5 and as shown corresponding to the arrows labeled ‘6’ and ‘7’ in FIG. 3.

In step 412, corresponding to arrows labeled ‘5’ in FIG. 3, a notice is sent to each matching participating account holder from the PRS who has conducted a transaction on an account for the purchase of a product with a matching product identifier of a recalled product. The notice sent to the account holder contains recall notification verbiage provided by the supplier for delivery to the account holder who conducted the corresponding transaction for the purchase of a recalled product, and may also include a respect recalled product GUID. The recall notification verbiage can be sent to each account holder via statement message, e-mail, direct mail, web message or other method. In step 414, the recall notification verbiage is received by the respective account holders who conducted the corresponding transactions for the purchase of a recalled product.

Alternatively, the recall notification verbiage can also include an identifier that uniquely identifies the account holder to whom the recall notification verbiage was sent, also known as the account holder's Globally Unique Identifier (GUID). When the account holder contacts the PRS, the account holder's GUID can be supplied to the PRS so that the PRS can associate the account holder with a product that had been recalled (e.g.; see reference numeral 520 in screen shot 500 of FIG. 5). The PRS can also send the account holder's GUID to the supplier of the recalled product. As such, the supplier will be able to associate the account holder, via the account holder's GUID, with the supplier's product that had been recalled and was purchased by the account holder.

In step 416, corresponding to arrows labeled ‘6’ and ‘7’ in FIG. 3, each account holder accesses a PRS network interface to send data to and receive data from the supplier and/or the PRS which may pertain to a previously purchased recalled product. By way of example, and not by way of limitation, the account holder can use a web-enabled device to access the PRS network interface via the Internet, such as via a user interface having an interactive display screen 600 as discussed below with respect to FIG. 6. Such access by the account holder may require the input of the recalled product GUID as received in the recall notice. In step 418, the transaction handler, the PRS, or their agent, collects a fee from the supplier for product recall message delivery services and distributes all or respective portions thereof to each participating entity that assisted in the product recall message delivery service.

FIG. 5 shows and exemplary interactive display screen 500 as a user interface by which an account holder can used a web-enabled device to access the PRS network interface via the Internet. Access by the account holder using the web-enabled device is graphically depicted in FIG. 1 at arrow ‘7’, in step 218 of FIG. 2, in FIG. 3 at arrow ‘6’, and in step 416 of FIG. 4. With the finding of the recalled product matches in the transaction data, such as at step 210 of FIG. 2 and step 410 of FIG. 4, the PRS, working in conjunction with the transaction handler, can derive and use other information from the matching transaction data. For instance, by mining the matching transaction data, the PRS can assign Globally Unique Identifiers (GUIDs) that characterize and specify the product recall. These data can then be communicated with the account holder at arrow ‘7’ of FIG. 1, at arrow ‘6’ of FIG. 3, at step 218 of FIG. 2, and step 416 of FIG. 4. These data can then be communicated with the supplier at arrow ‘7’ of FIGS. 1 and 3, at step 218 of FIG. 2, and step 416 of FIG. 4. For instance, the particular product(s) that were purchased by a particular account holder can each be assigned a recalled product GUID 506 for rendering on display screen 500. The particular transaction in which the particular product(s) were purchased by the particular account holder can be assigned a transaction GUID 508 for rendering on display screen 500. The particular merchant that sold the particular product(s) to that particular account holder can be assigned a merchant GUID 510 for rendering on display screen 500. The particular location at which the particular merchant sold the particular product(s) to the particular account holder can be assigned a merchant location GUID 512 for rendering on display screen 500.

The account holder can input a personal injury report 514 and/or a property damage report 516 on display screen 500. With receipt of input from the account holder on display screen 500, the PRS can assign a recalled product incident GUID 518 that is communicated for future reference to the supplier. Optionally, the account holder's GUID 520 may be auto-populated or can be supplied as input the account holder. Recalled product supplier verbiage 522, and an image of the recalled product 524, as may be suggested by the supplier of the recalled product, may be rendered on display screen 500. A user of a web-enable device that renders the display screen 500 may scroll the rendered imaged horizontally by using virtual navigation tool 502 and vertically by using virtual navigation tool 504 as in common in interactive applications

Exemplary Payment Processing System

FIG. 6 illustrates another exemplary payment processing system 600 having a Product Recall Service 630 implementations of which, as disclosed above, can be operated in the environment of FIG. 1 for the method 200 of FIG. 2, and in the environment 300 of FIG. 3 for the method 400 of FIG. 4. Payment processing system 600 has a plurality of accounts 608 each of which is held by a corresponding account holder (1) 608 through account holder (A) 608, where A can be up to and greater than a ten eight digit integer. A transaction includes participation from different entities that are each a component of the payment processing system 600. The payment processing system 600 has a plurality of merchants (m) 610 that includes merchant (1) 610 through merchant (M) 610, where M can be up to and greater than an eight digit integer. Payment processing system 600 includes account user (1) 608 through account user (AU) 608, where AU can be as large as a ten digit integer or larger. Each account user (au) conducts a transaction with merchant (m) 610 for goods and/or services using the account that has been issued by an issuer (i) 604 to a corresponding account holder (a) 608. Data from the transaction on the account is collected by the merchant (m) 610 and forwarded to a corresponding acquirer (a) 606 (e.g., the acquirer (q) 604). Acquirer (a) 606 forwards the data to transaction handler 602 who facilitates payment for the transaction from the account issued by the issuer (i) 604 to account holder (a) 608. Payment processing system 600 may include a plurality or transaction handlers (not shown) for respective acquirers and issuers, each participating in one or more product recall services, or the same product recall service.

Payment processing system 600 has a plurality of issuers (1-i) 604. Each issuer (i) 604 may be assisted in processing one or more transactions by a corresponding agent issuer (ai) 604, where ‘i’ can be an integer from 1 to I, where ‘ai’ can be an integer from 1 to AI, and where I and AI can be as large as an eight digit integer or larger. Payment processing system 600 has a plurality of acquirers (q) 606. Each acquirer (q) 606 may be assisted in processing one or more transactions by a corresponding agent acquirer (aq) 606, where ‘q’ can be an integer from 1 to Q, where aq can be an integer from 1 to AQ, and where Q and AQ can be as large as a eight digit integer or larger.

The transaction handler 602 may process a plurality of transactions within the payment processing system 600. The transaction handler 602 can include one or a plurality or networks and switches (ns) 602. Each network/switch (ns) 602 can be a mainframe computer in a geographic location different than each other network/switch (ns) 602, where ‘ns’ is an integer from one to NS, and where NS can be as large as a four digit integer or larger.

Dedicated communication systems 620, 622 (e.g., private communication network(s)) facilitate communication between the transaction handler 602 and each issuer (i) 604 and each acquirer (a) 606. The Network 612, via e-mail, the World Wide Web, cellular telephony, and/or other optionally public and private communications systems, can facilitate communications 622a-622e among and between each issuer (i) 604, each acquirer (a) 606, each merchant (m) 610, each account holder (a) 608, and the transaction handler 602. Alternatively and optionally, one or more dedicated communication systems 624, 626, and 628 can facilitate respective communications between each acquirer (a) 606 and each merchant (m) 610, each merchant (m) and each account holder (a) 608, and each account holder (a) 608 and each issuer (i) 604, respectively. Product Recall Service 630, implementations of which are described above with respect to FIGS. 1-5, can be in communication through Network 612 with the transaction handler 602, issuers 604, account holders 608, and acquirers 606. Each acquirer (q) 606 may be assisted in processing one or more transactions by a corresponding agent acquirer (aq) 606, where ‘q’ can be an integer from 1 to Q, where aq can be an integer from 1 to AQ, and where Q and AQ can be as large as a eight digit integer or larger.

Merchant (m) 610 may be a person or entity that sells goods and/or services. Merchant (m) 610 may also be, for instance, a supplier, a distributor, a retailer, a load agent, a drugstore, a grocery store, a gas station, a hardware store, a supermarket, a boutique, a restaurant, or a doctor's office. In a business-to-business setting, the account holder (a) 608 may be a second merchant (m) 610 making a purchase from another merchant (m) 610. Merchant (m) 610 may utilize at least one point-of-interaction terminal (e.g., Point of Service or browser enabled consumer cellular telephone) that can communicate with the account user (au) 608, the acquirer (a) 606, the transaction handler 602, or the issuer (i) 604. Thus, the point-of-interaction terminal is in operative communication with the payment processing system 600.

Typically, a transaction begins with account user (au) 608 presenting the portable consumer device to the merchant (m) 610 to initiate an exchange for a good or service. The portable consumer device may be associated with an account (e.g., a credit account) of account holder (a) 608 that was issued to the account holder (a) 608 by issuer (i) 604.

The portable consumer device may be in a form factor that can be a payment card, a gift card, a smartcard, a smart media, a payroll card, a healthcare card, a wrist band, a machine readable medium containing account information, a keychain device, such as a SPEEDPASS® device commercially available from ExxonMobil Corporation, a supermarket discount card, a cellular telephone, personal digital assistant, a pager, a security card, an access card, a wireless terminal, or a transponder. The portable consumer device may include a volatile or non-volatile memory to store information such as the account number or an account holder (a) 608's name.

Merchant (m) 610 may use the point-of-interaction terminal to obtain account information, such as a number of the account of the account holder (a) 608, from the portable consumer device. The portable consumer device may interface with the point-of-interaction terminal using a mechanism including any suitable electrical, magnetic, or optical interfacing system such as a contactless system using radio frequency or magnetic field recognition system or contact system such as a magnetic stripe reader. The point-of-interaction terminal sends a transaction authorization request to the issuer (i) 604 of the account associated with the portable consumer device. Alternatively, or in combination, the portable consumer device may communicate with issuer (i) 604, transaction handler 602, or acquirer (a) 606.

Issuer (i) 604 may authorize the transaction and forward same to the transaction handler 602. Transaction handler 602 may also clear the transaction. Authorization includes issuer (i) 604, or transaction handler 602 on behalf of issuer (i) 604, authorizing the transaction in connection with issuer (i) 604′s instructions such as through the use of business rules. The business rules could include instructions or guidelines from the transaction handler 602, the account holder (a) 608, the merchant (m) 610, the acquirer (a) 606, the issuer (i) 604, a related financial institution, or combinations thereof. The transaction handler 602 may maintain a log or history of authorized transactions. Once approved, the merchant (m) 610 may record the authorization, allowing the account user (au) 608 to receive the good or service from merchant (m) or an agent thereof.

The merchant (m) 610 may, at discrete periods, such as the end of the day, submit a list of authorized transactions to the acquirer (a) 606 or other transaction related data for processing through the payment processing system 600. The transaction handler 602 may compare the submitted authorized transaction list with its own log of authorized transactions. The transaction handler 602 may route authorization transaction amount requests from the corresponding the acquirer (a) 606 to the corresponding issuer (i) 604 involved in each transaction. Once the acquirer (a) 606 receives the payment of the authorized transaction from the issuer (i) 604, the acquirer (a) 606 can forward the payment to the merchant (m) 610 less any transaction costs, such as fees for the processing of the transaction. If the transaction involves a debit or pre-paid card, the acquirer (a) 606 may choose not to wait for the issuer (i) 604 to forward the payment prior to paying merchant (m) 610.

There may be intermittent steps in the foregoing process, some of which may occur simultaneously. For example, the acquirer (a) 606 can initiate the clearing and settling process, which can result in payment to the acquirer (a) 606 for the amount of the transaction. The acquirer (a) 606 may request from the transaction handler 602 that the transaction be cleared and settled. Clearing includes the exchange of financial information between the issuer (i) 604 and the acquirer (a) 606 and settlement includes the exchange of funds. The transaction handler 602 can provide services in connection with settlement of the transaction. The settlement of a transaction includes depositing an amount of the transaction settlement from a settlement house, such as a settlement bank, which transaction handler 602 typically chooses, into a clearinghouse, such as a clearing bank, that acquirer (a) 606 typically chooses. The issuer (i) 604 deposits the same from a clearinghouse, such as a clearing bank, which the issuer (i) 604 typically chooses, into the settlement house. Thus, a typical transaction involves various entities to request, authorize, and fulfill processing the transaction.

The payment processing system 600 will preferably have network components suitable for scaling the number and data payload size of transactions that can be authorized, cleared and settled in both real time and batch processing. These include hardware, software, data elements, and storage network devices for the same. Examples of payment processing system 600 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 602 can include one or more data centers for processing transactions, where each transaction can include up to 100 kilobytes of data or more. The data corresponding to the transaction can include information about the types and quantities of goods and services in the transaction, information about the account holder (a) 608, the account user (au) 608, the merchant (m) 610, tax and incentive treatment(s) of the goods and services, coupons, rebates, rewards, loyalty, discounts, returns, exchanges, cash-back transactions, etc. By way of example, network/switch (ns) 602 can include one or more mainframe computers (e.g., one or more IBM mainframe computers) for one or more server farms (e.g., one or more Sun UNIX Super servers), where the mainframe computers and server farms can be in diverse geographic locations. Each issuer (i) 604 (or agent issuer (ai) 604 thereof) and each acquirer (a) 606 (or agent acquirer (aq) 606 thereof) can use or more router/switch (e.g., Cisco™ routers/switches) to communicate with each network/switch (ns) 602 via dedicated communication systems.

Transaction handler 602 can store information about transactions processed through payment processing system 600 in data warehouses such as may be incorporated as part of the plurality of networks/switches 602. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system 600 over paying and being paid by cash, or other traditional payment mechanisms.

The VisaNet® system is an example component of the transaction handler 602. Presently, the VisaNet® system is operated in part by Visa Inc. As of 2007, the VisaNet® system Inc. was processing around 500 million transaction daily, on over 1 billion accounts used in over 170 countries. Financial instructions numbering over 16,000 connected through the VisaNet® system to around 30 million merchants (m) 610. In 2007, around 81 billion transactions for about 4 trillion U.S. dollars were cleared and settled through the VisaNet® system, some of which involved a communication length of around 24,000 miles in around two (2) seconds.

Advantageously, Product Recall Service 630, via the network 612, can facilitate real time alerts that can be generated from POS transactional data and prior registrations of account holders with Product Recall Service 630. These ‘e-alerts’ provide both consumer safety and limitations on products liability of manufacturers, and suppliers such as distributors and wholesalers, and retailers by providing real time warnings. Each such warning can include information about defective and dangerous products that have been purchased by a consumer, and the warning or e-alert can be electronically delivered to a logical address of the consumer or the issuer of an account of the consumer, such as via a cellular telephone or a mobile web enable computing device.

The various steps or acts in a method or process may be performed by hardware executing software, and may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in computer readable medium that can be loaded onto a general purpose computer, a special purpose computer, or other programmable apparatus.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A method comprising a plurality of steps each being performed by hardware executing software, wherein the steps include:
receiving a plurality of different recall notices from a plurality of different suppliers of a plurality of different recalled products;
for transactions conducted with a plurality of different merchants on a plurality of different accounts issued to a plurality of different account holder by a plurality of different issuers, each said transaction identifying a purchased item, comparing an identifier for each of the purchased items of the transactions with an identifier for each said recalled product to identify each said transaction where the purchased item was one of the recalled products; and
for each said item purchased in each said transaction that corresponds to each of the recalled products, sending a recall message.

2. The method as defined in claim 1, wherein:
the sending of the recall message further comprises sending the recall message for delivery to a logical address selected from the group consisting of:
a logical address of each said issuer of each said account used to conduct one of the transactions to purchase one of the recalled products; and
a logical address of each said account holder of each said account used to conduct one of the transactions to purchase one of the recalled products.

3. The method as defined in claim 2, wherein the steps further comprise:
receiving a product recall service fee from each said supplier of each said recalled product; and
paying at least a portion of each said product recall service fee to each said issuer of each said account used to conduct one of the transactions to purchase one of the recalled products.

4. The method as defined in claim 1, wherein the recall message is sent as a delivery that is selected from the group consisting of:
a delivery to a logical address of each of the account holders who conducted the corresponding said transaction to purchase one of the recalled products;
a delivery to a logical address of each of the issuers who issued one of the accounts to one of the account holders who conducted the corresponding said transaction to purchase one of the recalled products, wherein each of the deliveries includes an identifier of each of the account holders to whom the issuer issued the account used to purchase one of the recalled products;
a delivery to a logical address of each of the suppliers of recalled products, wherein each of the deliveries includes an identifier of each of the account holders who purchased one of the recalled products; and
a delivery that includes a combination of the foregoing deliveries.

5. A non-transitory computer readable medium comprising instructions which, when executed by a computing apparatus, performs the method of claim 1.

6. A method comprising a plurality of steps each being performed by hardware executing software, wherein the steps include:
receiving a recall message from each of a plurality of suppliers, each said recall message identifying a recalled product and a corresponding message for the recalled product;
receiving data for a plurality of transactions each being conducted on an account by an account holder with a merchant, wherein the data for each said transaction includes information sufficient to identify the account holder and at least one item purchased in the transaction;
deriving each said item purchased in each said transaction that corresponds to each of the recalled products from:
the data for the plurality of transactions; and
a database identifying:
a plurality of said account holders each having an account and a logical address;
the plurality of suppliers; and
a plurality of said merchants;
and
for each said item purchased in each said transaction that corresponds to each of the recalled products, sending the corresponding said recall message for delivery to the logical address of the account holder who conducted the corresponding said transaction.

7. The method as defined in claim 6, wherein:
each said recall message includes a globally unique identifier; and
the steps further comprise receiving the globally unique identifier from the corresponding said account holder to which the corresponding said recall message was sent.

8. The method as defined in claim 7, wherein the steps further comprise sending each said globally unique identifier received from each said account holder to the corresponding said supplier of the recalled product that was purchased in a corresponding said transaction conducted by the account holder from whom the globally unique identifier was received.

9. The method as defined in claim 6, wherein:
each said transaction is conducted in a payment processing system in which a transaction handler processes a plurality of transactions;
each said transaction is characterized by one said account holder and one said merchant engaging in the transaction that is conducted upon one said account;
each issuer has issued one said account to one said account holder; and
each said merchant submits each said transaction to a corresponding said acquirer for processing by the transaction handler who requests the corresponding said issuer of the one said account to disburse funds from the corresponding said account holder for the transaction, and wherein the corresponding said issuer of the one said account forwards the funds to the transaction handler who forwards the funds to the corresponding said acquirer to disburse the funds to the merchant for the transaction.

10. A non-transitory computer readable medium comprising instructions which, when executed by a computing apparatus, performs the method of claim 6.

11. In a payment processing system in which a transaction handler processes a plurality of transactions each characterized by an account holder and a merchant engaging in the transaction upon an account, wherein an issuer has issued the account to the account holder, and wherein the merchant submits the transaction to an acquirer for processing by the transaction handler who requests the issuer to disburse funds from the account holder for the transaction, and wherein the issuer forwards the funds to the transaction handler who forwards the funds to the acquirer to disburse the funds to the merchant for the transaction, a computer-implemented method comprising a plurality of steps each being performed by hardware executing software, wherein the steps include:
receiving a transmission including a registration for participation in a product recall service from:
each of a plurality of said issuers for respective said account holders to respectively register each as a participating account holder;
a supplier to register as a participating supplier; and
each of a plurality of said acquirers for a respective plurality of said merchants to respectively register each said merchant as a participating merchant;
receiving, from the participating supplier, a recall message that includes:
an identifier for a product; and
a message for a recall of the product;
receiving, from the participating merchants, a plurality of transmissions each including data from one said transaction between one said participating merchant and one said participating account holder, wherein the data in each said transmission includes information sufficient to identify:
the participating said account holder conducting the one said transaction; and
one or more said items that were purchased in the one said transaction;
matching, using information from the received plurality of transmissions, the received identifier for the product against the one or more said items that were purchased in the one said transaction within the data for each said transmission;
and
for each match:
identifying each said issuer who issued the corresponding said account upon which the corresponding said transaction was conducted for a purchase of the recalled product; and
for each identified said issuer, sending a globally unique identifier respectively corresponding to each said participating account holder conducting one said transaction for the purchase of the recalled product on a corresponding account issued by the identified said issuer to the participating account holder, whereby the identified said issuer can send the message for the recall of the product for delivery to the respective said participating account holders corresponding to the transactions conducted for the purchase of the recalled product.

12. The method as defined in claim 11, wherein the steps further comprise sending the globally unique identifiers to the corresponding said participating supplier of the recalled product purchased in corresponding said transactions respectively conducted by the participating said account holder corresponding to the globally unique identifier.

13. The method as defined in claim 11, wherein the steps further comprise:
receiving a product recall service fee from each said supplier of a corresponding said recalled product; and
paying a portion of each said product recall service fee to each identified said issuer.

14. A non-transitory computer readable medium comprising instructions which, when executed by a computing apparatus, performs the method of claim 11.

15. In a payment processing system in which a transaction handler processes a plurality of transactions each characterized by an account holder and a merchant engaging in the transaction upon an account, wherein an issuer has issued the account to the account holder, and wherein the merchant submits the transaction to an acquirer for processing by the transaction handler who requests the issuer to disburse funds from the account holder for the transaction, and wherein the issuer forwards the funds to the transaction handler who forwards the funds to the acquirer to disburse the funds to the merchant for the transaction, a computer-implemented method comprising a plurality of steps each being performed by hardware executing software, wherein the steps include:
receiving a transmission including a registration for participation in a product recall service from:
each of a plurality of said account holders to respectively register each as a participating account holder;
a supplier to register as a participating supplier; and
each of a plurality of acquirers for a respective plurality of said merchants to respectively register each said merchant as a participating merchant;
receiving, from the participating supplier, a recall message that includes:
an identifier for a product; and
a message for a recall of the product;
receiving a plurality of transmissions each including data from one said transaction between one said participating merchant and one said participating account holder, wherein the data from each said transaction includes information sufficient to identify:
the participating said account holder conducting the transaction; and
one or more said items that were purchased in the transaction;
matching, using information from the received plurality of transmissions, the received identifier for the product against the one or more said items that were purchased in the one said transaction within the data for each said transmission;
and
for each match, sending to the participating account holder corresponding to the respective transaction, the corresponding said message for the recall of the product.

16. The method as defined in claim 15, wherein the plurality of transmissions, each including data from one said transaction between one said participating merchant and one said participating account holder, are respectively received from the one said participating merchant.

17. The method as defined in claim 15, wherein the plurality of transmissions, each including data from one said transaction between one said participating merchant and one said participating account holder, are received from the transaction handler.

18. The method as defined in claim 15, wherein:
the message for the recall of the product includes a globally unique identifier; and
the steps further comprise receiving the globally unique identifier from each said participating account holder receiving the message for the recall of the product.

19. The method as defined in claim 15, wherein the steps further comprise:
for each said match, assigning a globally unique identifier to:
each particular recalled product that was purchased by a particular said account holder;
a particular said transaction in which each said particular recalled product was purchased by the particular account holder;
the particular said merchant that sold each said particular recalled product to the particular account holder; and
a particular location at which the particular merchant sold each said particular recalled product to the particular account holder;
and
sending the globally unique identifiers to the supplier.

20. A non-transitory computer readable medium comprising instructions which, when executed by a computing apparatus, performs the method of claim 15.
